(19) United States
(12) Patent Application Publication
(10) Pub. No.: US 2011/0208631 A1
(43) Pub. Date: Aug. 25, 2011

(54) SYSTEM AND METHOD FOR MORTGAGE APPLICATION RECORDING

(75) Inventors: Troy Glick, Commack, NY (US); Richard Dinerman, Belle Harbor, NY (US); John Tuohy, Rockaway Park, NY (US); Nicholas Zaffino, Danbury, CT (US)

(73) Assignee: Fraud Analysis Control Technology, Corp., Brooklyn, NY (US)

(21) Appl. No.: 13/034,073

(22) Filed: Feb. 24, 2011

Related U.S. Application Data
(60) Provisional application No. 61/307,562, filed on Feb. 24, 2010.

(51) Int. Cl. G06Q 40/00

(52) U.S. Cl. 705/35

(57) ABSTRACT

A system and method for mortgage application clearinghouse is disclosed. In particular, the present disclosure is directed to a centralized mortgage application recording system for online data processing, recording and maintenance of mortgage application-related data.

### CROSS-REFERENCE TO RELATED APPLICATION

The present application claims priority to U.S. Provisional Application Ser. No. 61/307,562 filed on Feb. 24, 2010, the entire contents of which is incorporated by reference herein.

### BACKGROUND

1. Field

The present disclosure relates generally to a mortgage application clearinghouse. In particular, the present disclosure is directed to a system and method for centralized online data processing, recording and maintenance of mortgage application-related data.

2. Description of the Related Art

Currently, mortgage applications are processed by individual lending institutions without reporting the application data to a centralized database. Such lack of centralized record keeping prevents analysis and audit of the mortgage applications by third party actors, such as governmental agencies, financial institutions, mortgage brokers, originators, consumer advocates, etc. The porous recordation system provides various opportunities for abuse and various fraudulent activities, such as multiple mortgage application to multiple lending institutions for a single property. Such activities may go unnoticed until months or even years after the loan was issued to the lender. There is a need for a centralized mortgage clearinghouse to provide for rapid fraud detection.

### SUMMARY

The present disclosure provides for a mortgage application recording system (“MARS”), which provides for a mortgage clearinghouse having an online (e.g., web-based) mortgage application submission client. MARS allows mortgage originators, mortgage lenders, government agencies, and consumer advocate groups to analyze and control mortgage application fraud by validating mortgage applicants and property. MARS further allows for assigning of the application to lending institutions to process the lien. MARS may be embodied in a variety of hardware embodiments including a scalable server architecture that communicates with a plurality of clients that may be deployed on a variety of personal computing devices.

The MARS web-based application prevents fraud by validating mortgage applications submitted online by a mortgage originator or their agents. The MARS also assigns the applications to a mortgage lender and helps government agencies in analyzing and regulating the activities of mortgage professionals and the related mortgage applications.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is a schematic diagram of a hardware implementation of a mortgage application recording system according to the present disclosure;

FIG. 1B is a schematic diagram of a hardware implementation of a mortgage application recording system according to the present disclosure;

FIG. 2 is a flow diagram of an ASP.NET authentication process according to the present disclosure;

FIG. 3 is a flow diagram of a session key identification process according to the present disclosure;

FIG. 4 is a flow diagram of an ASP.NET file request process according to the present disclosure;

FIG. 5 is a flow diagram of an interface between the live and reporting databases according to the present disclosure;

FIG. 6 is a flow diagram of a reporting database job flow according to the present disclosure;

FIG. 7 is a flow diagram of a reporting database job flow according to the present disclosure;

FIG. 8 is a flow diagram of a live database job flow according to the present disclosure;

FIG. 9 is a schematic diagram of an ASP.NET directory structure according to the present disclosure; and

FIG. 10 illustrates a flow diagram showing a method for verifying mortgage application according to the present disclosure.

### DETAILED DESCRIPTION

Particular embodiments of the present disclosure are described herein below with reference to the accompanying drawings. In the following description, well-known functions or constructions are not described in detail to avoid obscuring the present disclosure in unnecessary detail.

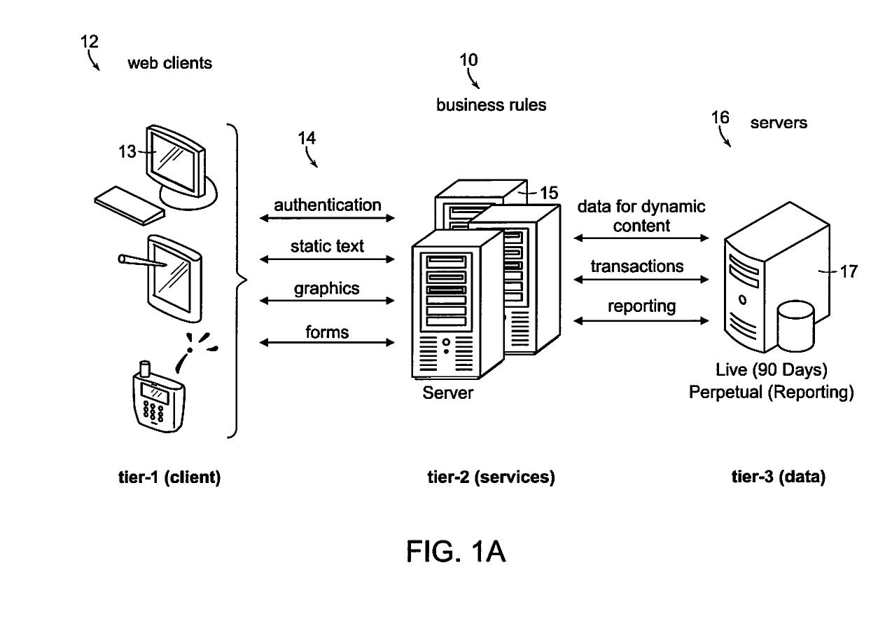

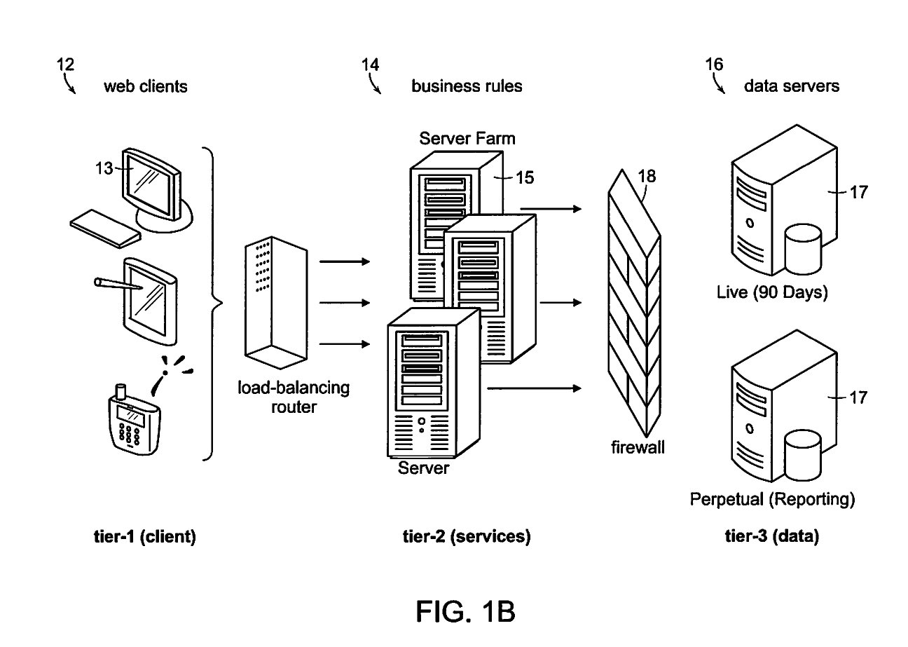

The mortgage application recording system (“MARS”) 10 has a three-tier layer architecture including a client layer 12, a services layer 14 and a data layer 16. The layers 12, 14, and 16 may be implemented in one of the example hardware configurations shown in FIGS. 1A and 1B. The client layer 12 may be deployed on a variety of computing devices 13 including, but not limited to, personal computers, laptops, mobile devices, etc. The services layer 14 may be deployed on a variety of servers 15 including, but not limited to, web servers, application servers, etc. The services layer 14 interfaces between the client layer 12 and the data layer 16 by collecting and displaying data to and from the users that is, in turn, stored in the data layer 16. The data layer 16 may also be deployed on a variety of servers 17 including, but not limited to data servers. In embodiments, the services layer 14 and data layer 16 may be implemented as a cloud computing, or any other scalable computing environment.

The client layer 12 interfaces with the users via applications and presentations provided by the services layer 14 and displayed on the computing devices 13. In particular, the client layer 12 presents data to the user and accepts input therefrom. The services layer 14 includes business logic, validations or calculations related to the data exchanged with the users through the client layer 12. The data layer 16 includes methods that aid the services layer to connect to the data bases and perform requested actions, such as returning or updating data. The three-tier architecture is a versatile and modular infrastructure intended to improve usability, flexibility, interoperability and scalability. Three-tier architecture provides the opportunity to insert an additional firewall 18 as shown in FIG. 1B, such that even if the service layer 14 is compromised, the data layer 16 is secure.

MARS 10 provides for a centralized repository of mortgage applications which are stored in the data layer 16. The data is collected from various users (e.g., applicants, mortgage brokers, agents, lending institutions, etc.) filing mortgage applications via the client layer 12. In addition, the data is also presented for validation and review by other authorized users (e.g., government agencies, consumer advocates, lending institutions, etc.). The service layer 14 provides for collection and extraction of data and interfaces the client layer 12 with the data layer 16. The mortgage applications that are verified and validated are then provided to the lending institutions interested in providing mortgages to the applicants.

The client layer 12 may be implemented as a first-tier hardware layer and includes a contributor external network. The contributor network may be embodied as either a web-based interface or a transaction-based interface via the computing devices 13 in either real-time or asynchronous fashion, allowing a user to communicate with the MARS 10. For the web-based interface, a web browser client may be used to communicate via a HTTP(S) and other protocols with the servers 15 as discussed in more detail below. The servers 15 process the requests and deliver data and user-interfaces (e.g., via web pages) based on the requests.

The web browser client may include a user interface for accessing the MARS 10 and performing online real-time transactions. Since the MARS 10 contains sensitive data that is to be available through public wide area network connections (e.g., Internet), the web browser client is capable of using secure connections (e.g., 128-bit Secured Sockets Layer (“SSL”)). Any hardware device (e.g., smartphone, personal computer, etc.) capable of making a network connection to the Internet or other wide area network and running a browser may be used as a client to the MARS 10.

The client layer 12 also includes various interfaces, applications and presentation sub-layers implemented in one or more servers 15 that are also capable of establishing secure connections with the web browser client (e.g., via SSL). The servers 15 include a MARS application layer that is available on the publicly accessible Internet. This application layer is responsible for accepting web page requests, passing transaction requests to the servers 15, delivering the MARS web pages and return transaction web screen to the client web browser. The servers 15 may be associated with an IP address and a domain name usable by the browser client to access the server 15. Connections made thereto may be encrypted and secured using SSL encryption module.

The user interface component of the MARS 10 may be constructed as ASP.NET web pages. The client layer 12 may be implemented using ASP.NET which is available from Microsoft Corp. of Redmond, Wash., which allows for dynamic and complex Web development. ASP.NET also enables modular and scalable development of powerful web applications. Applications developed in ASP.NET are highly extensible. ASP.NET supports URL rewriting and URL mapping, which enable creation of web applications with clean URLs that support search engine optimization. ASP.NET also supports Object Oriented Programming (OOP) and is enriched with enhancement technologies such as AJAX controls and Infragistics controls.

The .NET Framework has two main components: the common language runtime (CLR) and the .NET Framework class library. The CLR is the foundation of the .NET Framework, which acts as an agent that manages code at execution time for both Windows and ASP.NET applications. The class library, the other main component of the .NET Framework, is an object-oriented collection of reusable components that may be used to develop applications for both Windows and the Web.

ASP.NET offers a secure environment for hosting multiple applications on a single Web server. Application Service Providers (ASPs) and Internet Service Providers (ISPs) are able to host multiple applications from different outside sources on a shared server and keep the applications isolated from each other and from critical resources on the server. ASP.NET's configuration system is designed to make it easy to isolate Web applications and to grant code access security permissions to individual applications.

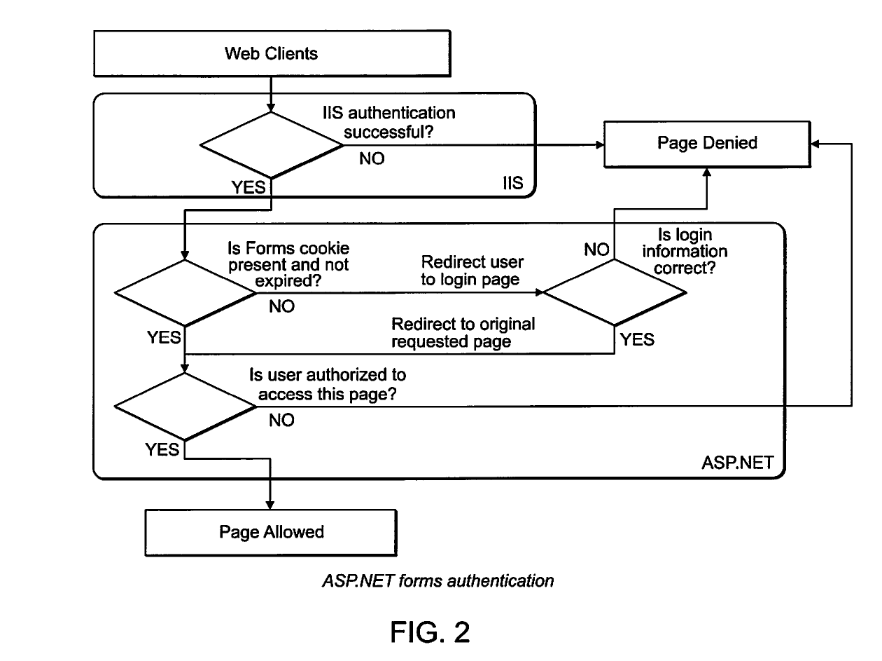

ASP.NET also facilitates form authentication, which is a two-step process which is illustrated in FIG. 2. Internet Information Services (IIS) authenticates the user and creates a Windows token to represent the user. IIS determines the authentication mode that it should use for a particular application by looking at IIS metabase settings. If IIS is configured to use anonymous authentication, a token for the IUSR_MACHINE account is generated and used to represent the anonymous user. IIS-then passes the token to ASP.NET. ASP.NET also performs its own authentication. The authentication method used is specified by the mode attribute of the authentication element.

If the user requests a page that requires authenticated access and that user has not previously logged on to the site, then the user is redirected to a configured logon page. The logon page prompts the user to supply credentials, such as a user name and password. Non-users may be presented with an opportunity to initiate account creation process. These credentials are then passed to the server and validated against a user store, such as a SQL Server database. After the user's credentials are authenticated, the user is redirected to the originally requested page. Subsequent requests are issued with the cookie in the request headers; they are authenticated and authorized by an ASP.NET event handler using whatever validation method the application developer specifies.

The .NET Framework is also suitable for protecting sensitive data, with one of the more popular techniques being hashing. Hashing provides a simple method of scrambling data values that may be easily stored in a database and re-created using the original hash algorithm. Due to the increasing number of security threats, cryptography provides suitable protection for most application development projects.

The .NET Framework supports the following hash algorithms: MD5, SHA1, SHA256, SHA384 and SHA512. The supported algorithms range from 128 to 512 bits. The number of bits is directly proportional to the level of security provided by the hash algorithm. Conversely, as the number of the bits increase, performance degrades accordingly. MD5 is an algorithm that takes as input a message of arbitrary length and produces as output a digested or encrypted version of the input that uses 128-bits. SHA1 is the Secure Hash Algorithm (SHA) that uses 196 bits to encrypt the data. SHA256 is the SHA that uses 256 bits to encrypt the data. SHA384 is the SHA that uses 384 bits to encrypt the data. SHA512 is the SHA that uses 512 bits to encrypt the data.

Hashing may be enhanced with a salt value, which is a collection of random bytes added to the input value before the algorithm is applied. A salt value may be a random value generated by the system or an arbitrary value like user identification number (e.g., mortgage originator user ID “MOUID”). One of the limitations of hashing is that identical input values produce identical encoded values. That is, two users with the same password will have the same encoded string stored for their password. If a hacker views the data, they may notice trends and possibly crack the values. Adding a salt value to the hashing algorithm solves this problem.

ASP.NET also provides for session management. Session state that is tied to a single process requires that an application that relies on session state can only be serviced by the same process on the same machine. This prevents the possibility of deploying the application in a Web farm environment, where multiple machines are used to service requests independently, potentially from the same client. If session state is tied to the lifetime of the Web server process, it is also susceptible to disappearing if that process goes down for some reason.

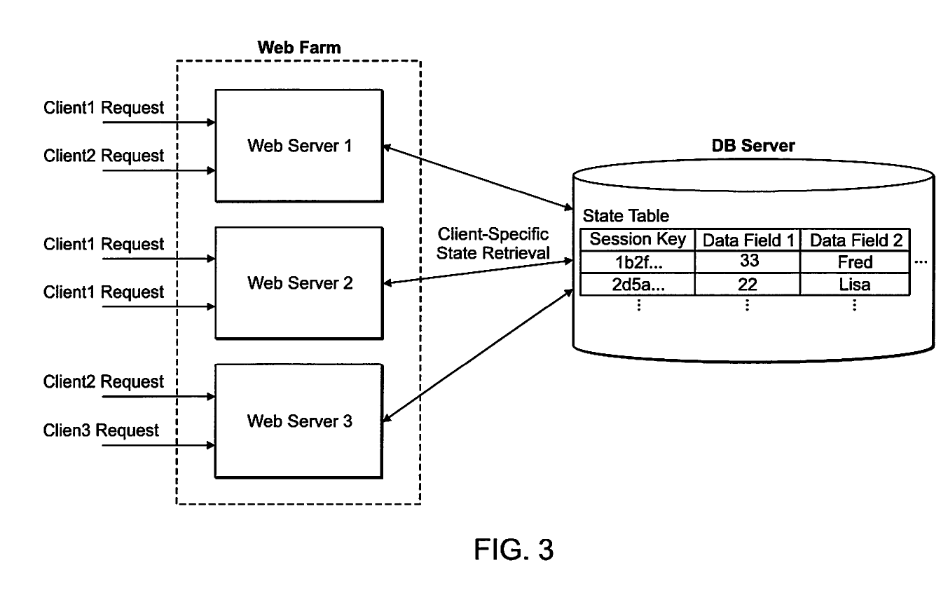

To build traditional ASP applications that scale to Web farms and/or maintain persistent client-specific state, session states may be avoided. In embodiments, client-specific state is maintained in a database running on a network-accessible server. To distinguish one client's state from another, the table (or tables) used to store state is indexed by the session key as illustrated in FIG. 3.

The ASP.NET also provides for asynchronous JavaScript+XML (“AJAX”) Control Toolkit, which is an open-source project built on top of the Microsoft ASP.NET AJAX framework. AJAX provides for write reusable, customizable and extensible ASP.NET AJAX extenders and controls, as well as a rich array of controls that can be used out of the box to create an interactive Web experience. With AJAX, web applications can retrieve data from the server asynchronously in the background without interfering with the display and behavior of the existing page.

Web servers may be implemented using Web Server (IIS).Net Framework and ASP.Net. The web server hosts and publishes content to the client browser. When IIS recognizes a page being an ASP.Net module (an aspx extension), it passes the request to the .Net Framework to load the module and handle the request. The ASP.Net pages are then loaded into memory and executed. The .Net Framework provides many utilities such as garbage collection, tracing, just-in-time compilation that manages the execution of ASP.Net modules. The ASP.Net page modules are where the MARS application logic is coded.

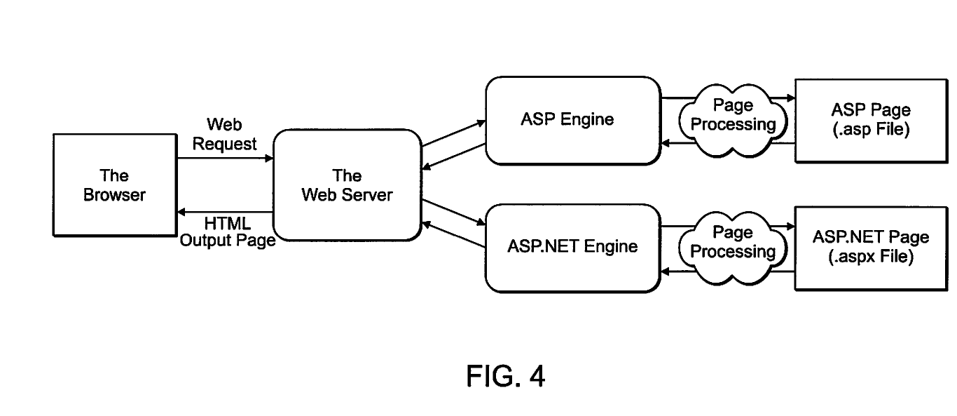

The web server also provides security via the Secured Socket Layer (SSL), allowing interactions between the user's browser and the web server to be encrypted. FIG. 4 shows a diagram representation, explaining how IIS handles an ASP.NET file request.

Network layer security may be managed by the network security configurations via a firewall. SSL uses a cryptographic system that uses two keys to encrypt data—a public key known to everyone and a private or secret key known only to the recipient of the message. Majority of the browsers support SSL, and many web sites use the protocol to obtain confidential information. By convention, URLs that require an SSL connection start with https: instead of http:. SSL creates a secure connection between a client and a server, over which any amount of data can be sent securely.

An SSL digital certificate needs to be procured for the SSL configuration. The server name must remain consistent with the certificate. All links shall use the same server name; otherwise, if the server is referred using an IP address or a local server name, etc., the user is provided with an alert indicating the certificate is inconsistent with the resource. IIS supports the configuration of one folder in the web application requiring SSL while other portion does not. The session information remains consistent between SSL portion of the web site and the non-SSL portion.

With reference to FIGS. 1A and 1B, the servers 15 may be implemented as a hardware layer and may include a mail transfer agent, which may be a simple mail transfer protocol (SMTP) server. The mail transfer agent provides a network communication end point for receiving text messages from the MARS 10. The mail transfer agent also provides a gateway for processing MARS notifications messages and report outputs that have been configured to be delivered by e-mail to an end user. The mail transfer agent may be configured to prevent delivery by e-mail of confidential data.

The servers 15 may also include a business service layer and a security layer. Each of the layers may be embodied across a variety of server configurations. The business services layer provides the business logic components, such as input data translation, user authentication, workflow management and security management. The business services layer accepts transactions, reports requests received through the interfaces layer and verifies the end-user authentication for access to the requested data view or manipulation and provides for access to the database layer and data for delivery through the interfaces layer.

The security layer performs authorization and validation of client communication through the interface layer. The authorization validation function provides a security check to ensure that a submitting user is authorized to perform the requested action or to access the requested data in order to process the properly formatted and validated input transaction.

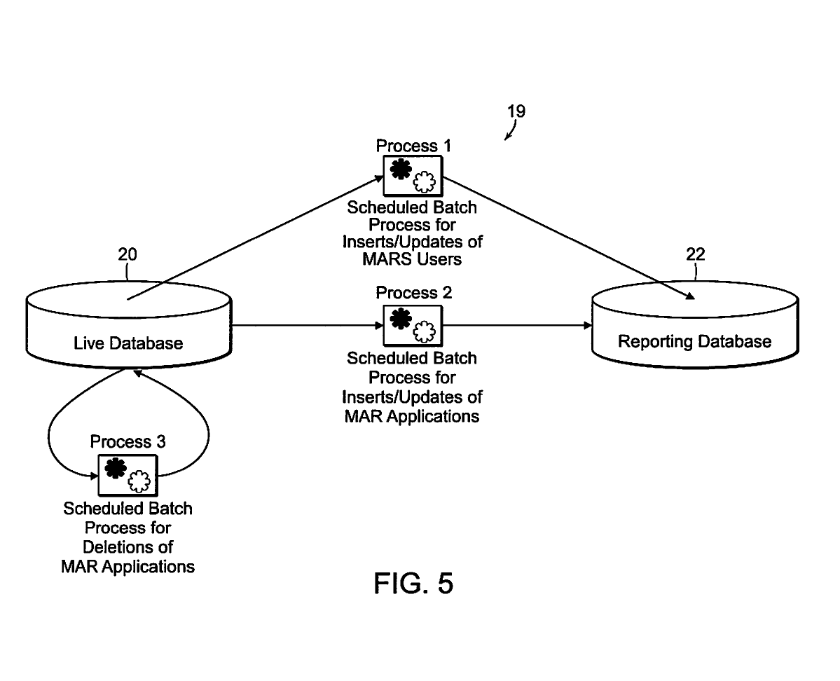

The data layer 16 includes a database layer 19 as shown in FIGS. 5-8, data storage layer, and data access layer. The database layer 19 provides persistent storage for mortgage application data. Additional data stored in the database layer includes indexing information, data modification audit trails and reports. Communication with the database layer may be established through an abstraction layer such as ADO.NET. A browser-based end user client interfaces with the database layer 19. These interfaces define data transport methods. The database layer 19 includes a live database 20 and a reporting database 22. The real time transactional data is stored in the live database 20, which then interfaces the new/modified real time transactional data from to the reporting database 22.

The data storage layer stores MARS data. This layer includes a relational database capable of transaction management through native read-consistency concurrency control. Data storage layer supports both dedicated and shared server connections, hardware clustering, and may be capable of supporting both high-volume on-line transactions as well as query intensive data reporting application use. The storage layer also includes the necessary data access layer allowing the application server to communicate necessary data updates and data requests. The data access layer may reside on a different server platform from the application server and allows for application-native TCP/IP communication and ADO.NET access from the services executing on the application server.

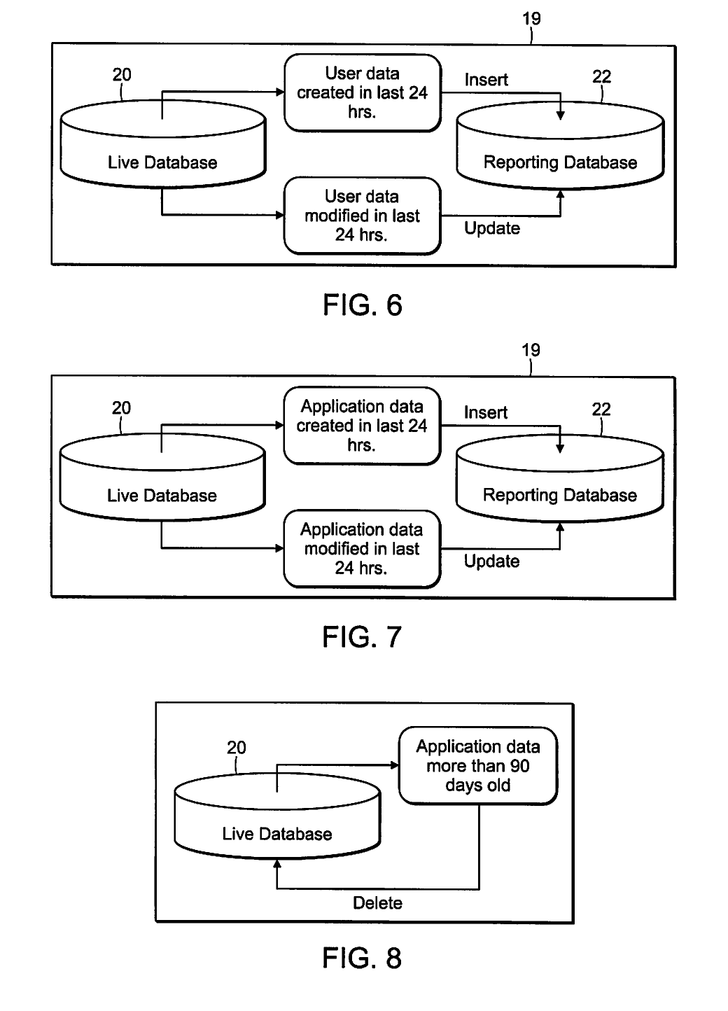

FIG. 5 illustrates the interface between the live and reporting databases 20 and 22. The update jobs may be run on a periodic basis (e.g., every 24 hours). These schedules can be configured using SQL Server Management Studio on the respective database servers or any other server configuration software. The reporting database 22 executes the jobs shown in FIGS. 6 and 7. The reporting database 22 updates user data and mortgage application data that was created or modified since previous successful execution of the interface. The live database 20 executes the jobs shown in FIG. 8. In particular, the live database 20 purges mortgage application data from the live database 20 that is older than a predetermined period of time (e.g., 90 days).

Ad-hoc Query Builder reporting may be used to allow users to search data or generate reports. In one embodiment, WebForms edition of EasyQuery.NET may be used. WebForms allows users to search data or generate reports online. EasyQuery.NET WebForms fully supports ASP.NET AJAX components to get all power of AJAX technology with ad-hoc query building and reporting. EasyQuery.NET allows for inclusion end-user-oriented query builder into ASP.NET web-site.

MARS 10 may be implemented using the command-line tool (e.g., aspnet_compiler.exe) or compilation option within Visual Studio. Application code may be compiled on the development machine before deploying the code on the servers 15. The compiler compiles a web application to prepare the application for deployment. However, the compiler can also compile a website after the code has been transferred to the servers 15, using so-called in-place compilation, without removing the code. Instead, the compiler simply creates and caches the compiled versions of the web pages to avoid delays for the first set of requests. Application code deployment may be accomplished by creating the virtual directory on the servers 15 and copying the entire site (including subdirectories) to the virtual directory. These files could be transferred on the web server, using FTP program, to a designated area.

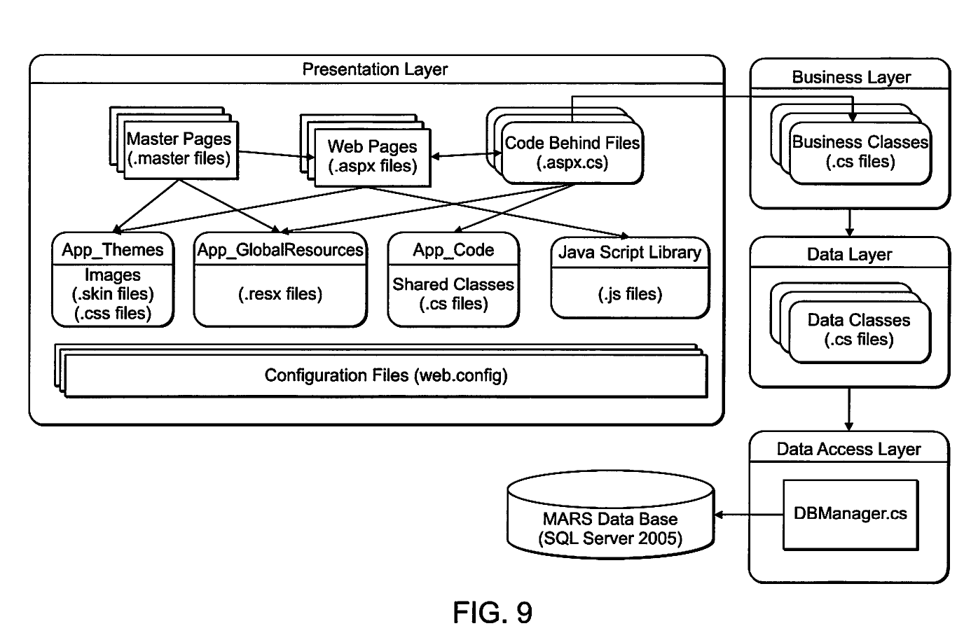

ASP.NET uses a new set of predefined directory names as shown in FIG. 9. In general, the ASP.NET directory structure can be determined by the developer's preferences. The reserved directory names are as follows:

App_Browsers is used to place browser specific definition files for the site;

App_Code is the directory used to store the raw code. The classes in this folder are automatically compiled into one assembly which is accessible in the code in every page in the site.

App_Data is the default director for the data storage or database like Access, SQL server express etc. This directory has write permission so that data can be inserted in the database.

App_LocalResources folder contains the localized resource files for each page in the site.

App_GlobalResources holds the resx files for the localized resource available to every page in the site.

App_Themes folder is used to store the themes of the site.

App_WebReferences folder is used to store the discovery and WSDL files of the references of the web services consumed by site.

Bin folder is used to store the compiled assemblies of the application and also the referenced assemblies, which are not installed in the Global Assembly Cache (GAC). GAC is a machine-wide cache of .NET assemblies for Microsoft's CLR platform.

MARS 10 allows for controlled access to the mortgage applications and provides for a variety of user accounts having limited access to the data. The user accounts may include back-office users, which are categorized as super-users, application administrators and application support users. Super-user accounts cannot be deleted and/or de-activated. This user has full access to all user accounts, and its logs, full read-access to all mortgage applications, ability to create and/or manage an application administrator, create and/or manage user accounts, resend email notification to pending activation accounts, force password reset and perform task on-behalf of any account user by selecting and setting user profile.

Application administrator accounts are allowed to enter and submit government regulators/consumer advocates (GRCA) registration, create and manage application support users, manage master account users like mortgage originator, mortgage lender and GRCA, accept or reject master account applications, resend email notification to pending activation accounts and force reset password. These accounts may also validate and set user profile to perform tasks on behalf of the user account, depending on the user accessibility, except change password, user creation, mortgage application creation and mortgage application status change.

Application support user accounts are a sub-user type of application administrator accounts. Application support user accounts are managed by application administrator and/or super-user accounts. These users usually perform the function of support desk (e.g., back-office) users handling day-to-day user queries. Users with this role have full access to the application data and are expected to perform the following tasks: enter and submit GRCA registration, validate and set user profile to perform tasks on behalf of the user account, depending on the user accessibility, except change password, user creation, mortgage application creation and mortgage application status change.

MARS 10 may also include key application user accounts, which are master user accounts and sub-accounts that have default limitations to data entry, data access, and specific data masking (e.g., only last four digits of Social Security Number (“SSN”)). Master user accounts may include mortgage originators, master lender and master government regulators/consumer advocates. Each of the accounts may have a corresponding MARS account number associated therewith.

Mortgage originator accounts are allowed to create and manage their mortgage agents, such as add, delete, suspend and send password reset. These accounts are also allowed to enter mortgage applications, assign mortgage application to lending institutions and terminate a mortgage application. Master lender accounts are allowed to create and manage mortgage lender agents and mortgage lender examinations, such as add, delete, suspend and send password reset. These accounts are also allowed to view un-assigned mortgage application having limited data visibility and view/query all assigned mortgage application to their institution.

Master Government Regulators/Consumer Advocates accounts are allowed to create and manage government user accounts, such as add, delete, suspend, and send password reset. In addition, these accounts are also allowed to view mortgage applications with full/limited data access depending on the profile assigned and view user accounts and its logs with full/limited data access depending on the profile assigned.

Sub-User accounts include mortgage originator, mortgage lender, and examination and government users. These accounts are created by their primary master account users. An email is sent to the new sub-user account's email ID when the accounts are created. Mortgage Agents are created and managed by their respective primary Mortgage Originator. Users with this role are allowed to enter mortgage application, assign mortgage application created by the mortgage agent to the lending institution. The accounts are also allowed to force the expiration of mortgage applications created by the mortgage agent. In embodiments, these accounts are also allowed, depending on permissions, to upload and batch files, assign or expire mortgage applications created by any mortgage agent operating under mortgage broker.

Mortgage lender agents are accounts that are created and managed by their respective primary mortgage lenders. Users with this role are allowed to view un-assigned mortgage application with limited data visibility, search for unassigned applications include mortgage application ID (“MARIN”) and applicants last name. These accounts may only search one query at a time. In addition, these accounts may view full details of assigned mortgage application to their institution. Users marked as mortgage lender examinations are allowed to view multiple assigned mortgage application using ad-hoc reporting.

Government regulator/consumer advocate users are created and managed by the master government regulators/consumer advocate official. Users with this role are allowed to view mortgage applications with full/limited data access equal to that of the master account as well as view user accounts and its logs with full/limited data access.

MARS 10 provides multiple user accounts having specific access permissions to the databases, e.g., reading, writing, executing and reporting. Access permissions may be specific to a user account or apply to an entire group of user accounts. The read permission refers to a user's capability to read the contents of specified mortgage applications. The write permission refers to a user's capability to write or modify the specified mortgage applications. The reporting permission refers to a user's capability to generate and view a report on the specified mortgage applications. The reports are generated by the MARS 10 as discussed in further detail below.

In embodiments, the reporting may be configured as multilevel reporting such that the MARS 10 providing specific users with only the data that the user account has access to. Thus, a mortgage lender account may receive reports listing all of the pending mortgage applications from its applicants, whereas a mortgage originator may receive reports including mortgage applications from multiple lenders. An administrator or government user account may view reports that are broader in scope.

In further embodiments, the reports may limit the view of each specific data point rather than grant complete access to a mortgage application. For example, a government regulator account may see all of the applications including all of its fields, whereas an FDIC auditor may only view mortgage applications from a single lender and may only view last four digits of an applicant's social security number or another identifier.

Each of the above described accounts may be created through a predetermined approval process. Master user account approval process may be performed by a clearinghouse, which manually reviews and verifies the registration request to approve/disapprove access to the system. The application for master user accounts may be submitted and reviewed online. An application administrator of the clearinghouse reviews the application and grants the applicant a specific account and/or sub-account, which determines user's rights as outlined above. The administrator may approve, disapprove or request for more details to verify submitted information.

Once the application is approved a notification (e.g., via email) is sent to the user. Account activation may then be performed online once the account user receives an email having required details to complete the account activation. The email includes a URL link that sends the user to a corresponding website to verify activation. Accounts of various types are subject to different verification guidelines. In embodiments, master user accounts of mortgage originators and mortgage lenders have online registration and may also be reviewed manually before allowing access to MARS 10. Government master account registration may be directed to a phone number connecting them to an administrative support person, who helps in creating and setting up the account. The accounts may then also be reviewed manually before allowing access to the request. Mortgage originator master account user creation process may be performed in a hybrid manner—online and offline. In addition to an online application, the user may also print and sign a license agreement to be delivered to the clearinghouse.

Each of the accounts is allowed a specific view of the MARS 10 and the associated databases. Different views of the MARS allow users of different accounts to perform different tasks. The super-users may list registered users, accept, reject, resend activation, force reset password, list master and sub accounts, resend activation, force reset password and set user profile. Each of the accounts may also generate reports pertaining to the mortgage applications that the user account may access.

Application administrators may list registered users, accept, reject, resend activation, force password reset, validate and set user profile. Application support users may validate and set user profile. Mortgage originator account may perform user maintenance, user list, resend activation, force password reset, mortgage application, view batch data upload, view invalid application/s by batch upload. Mortgage originator may also modify invalid application details, view existing applications, list standard and custom ad-hoc reports.

MARS 10 may generate standard reports and ad-hoc reports. Standard reports are required within system to view and print reports for analysis purpose. Ad-hoc reports are provided for all the user accounts and include limited data output based on default user account access as listed above. In embodiments, the reports may be generated and then aggregated and/or filtered by any suitable field, for example, by zip code, mortgage originator, number of applications per a specified field (e.g., zip code). In addition, if there is a relationship (e.g., regulatory or business) between one or more users, the users may filter the reports based on the relationship, for example, a mortgage lender may sort the report based on the originators. The reports may also include a map of the properties whose mortgage applications are included in the report. In embodiments, the report may include an exportable value that may be read by a mapping application. The mapped results may also be sorted and filtered based on the desired fields, e.g., zip code, lender, originator, etc.

Mortgage agent accounts may view batch data upload, view invalid applications, view existing applications as well as list standard and custom ad-hoc reports. The mortgage lender accounts may perform user maintenance, user list, resend activation, force password reset, manage sub-account information, search un-assigned application, and view assigned applications and list standard and custom ad-hoc reports. Mortgage lender agent may search un-assigned applications, view assigned applications and list standard and custom ad-hoc reports. Government regulators or consumer advocate master account may perform user maintenance, user list, resend activation, force password reset and list custom ad-hoc reports. The view of MARS afforded to the government master and user accounts only have a default view that is geared towards reporting functionality. Government user account may only generate various reports.

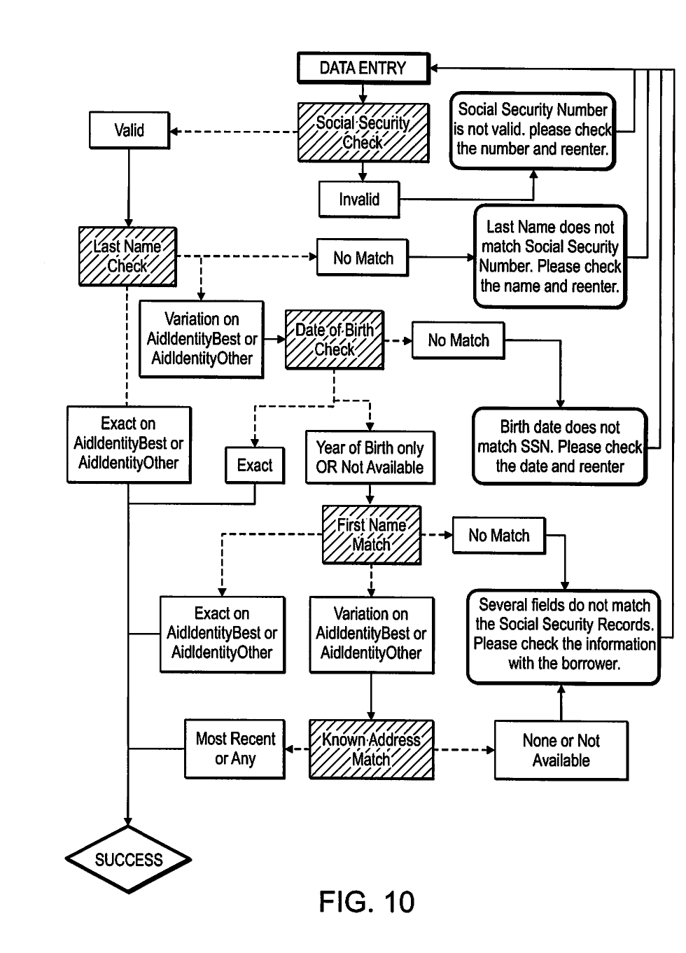

FIG. 10 shows a mortgage application process through MARS 10. Either a mortgage broker or an agent account is allowed to commence the mortgage application process. Mortgage application data may be entered via a web form (e.g., online single application entry form) or batch data upload (e.g., using pre-defined data entry template) via the client layer 12 as discussed above. During mortgage application creation process via online web form, the mortgage broker or agent logs into the system and enters the required data. The application is submitted and validated, and if validated, the application is created. The system then performs external validation, generates an auto-generated unique number, MARIN, for a successful/forced application, enters data into base tables and triggers internal validation to populate the internal validation match and redirect to the confirmation screen. During mortgage application creation process via batch data upload, the mortgage broker or agent logs in to the system and enters the application via a batch upload. Optionally, the user may also use an offline template for data entry, which may be xml and delimited.

After entry, the data is then validated through various sources to authenticate the information provided and the application is assigned a MARIN. MARIN is a mortgage application ID which is a 16 digit number starting with property state ID+last 2 digits of the year+12 digit sequential number. For instance, for an application created in year 2009 for a New York property would be 2009123456789123, where first two digits (“20”) is the New York state ID, followed by two digits (“09”) which are the last two digits of the year the application was created and the last twelve digits (“123456789123”) are the sequential system generated number. Once the MARIN number is assigned to the application, no changes may take place to the application other than the status change.

Data entry of the application is accomplished through the client layer 12. Data entry includes input of specific required fields including last name, first name, property address, SSN, date of birth, etc. The system validates the data provided with external third-party systems. The system verifies property address, SSN, etc. via government and third-party databases, such as United States Postal Service information may be used to validate property addresses in situations where an exact match is not available. The system also verifies the first and last name as well as any variations thereof. Each of the required fields may also be verified in relation to each other. In particular, date of birth, first and last names may be verified with the information associated with the SSN and the provided address. In embodiments, the validation process may be used to validate either all or some of the submitted information through a variety of sources and databases. Randomizing the validation process by varying the process and the sources provides for an additional layer of fraud prevention by minimizing the predictability of MARS 10.

If external application validation fails, the system shall populate one or more error texts. Verification failure may occur when one or more of the fields do not match other fields, such as but not limited to, birth date, last and first names not matching the SSN or SSN being an invalid number (e.g., a recent SSN number being associated with a late birth date). In case of online web form data entry, the system notifies the user with the errors and redirects the user back to the data entry form allowing data correction. The system also pre-populates a new form with data entered and possible highlights of errors. Since error checking is linear and failure occurs in the first instance, it is possible to fail, correct, and then fail in a new area.

In case of batch data upload, the system populates the error text field of the respective mortgage application. Once the external failure occurs, system allows modifying and/or may force application creation with comments.

MARS 10 uploads data file to the data layer 16 and assigns a unique identification to the upload process, which may be a unique user ID concatenated with date and time of upload. The system populates data in temporary tables, and validates the number of applications uploaded against a threshold defined at master broker account. If the number is less or equal and the application is uploaded during peak hours and the number of records are more than default threshold value as defined in system configuration, the records are processed off-line during off-peak hours. The users are also notified that the batch data uploaded would be processed during off-peak hours. If the number of records is less than a default threshold value, the batch data is uploaded and processed online. If uploaded during off-peak hours, the batch data is uploaded and processed online. If the number of records is more than allowed, the system returns an error message notifying the user (e.g., “your master account is not allowed to upload more than xxx number of records in one batch upload”).

Once application data is uploaded, the data is validated. The system performs a basic data validation and populates error text if needed. The system checks if all mandatory data is provided, and/or if the data format of all the required fields is correct. In addition to external validation, the system performs internal validation of valid records and populates actual tables. In embodiments, external validation may include review by other users, such as GRCA user accounts, to detect illegal activity such as fraud or discriminatory lending practices.

With online batch data processing, the system processes batch data online, performs data validation, and performs external validation for the valid records. The MARS 10 also populates MARIN for a successful/forced application, enters data into base tables, triggers internal validation to populate the internal validation match and displays confirmation screens. The confirmation includes the number of records successfully processed, the number of records which failed, an invalid records list, links to edit and re-submit invalid records individually, links to delete/purge invalid records and checkbox to forcefully create application with a free text box for comments (comments is mandatory for application is forced into the system).

With offline batch data processing, an automated process/program may be utilized to run during off-peak hours to process all data marked for off-line processing. This program performs for each batch marked to be processed offline data validation, external validation and populates MARIN for a successful application. The MARS 10 also enters data into base tables, deletes data from the batch upload tables, and triggers internal validation to populate the internal validation match. The MARS 10 may display a user interface that allows users to select and verify the batch upload data summary and error records, if any.

If external application validation passes, the system proceeds to internal validation process. Internal validation & MARIN generation process is triggered after an “insert” event (e.g., immediately after inserting data in the live database 20). The system checks internally, within the live database 20 and within the reporting database 22, up to a predetermined cut off period (e.g., 90 days) whether the mortgage application has been entered into MARS 10, namely, all mortgage application time stamped before the current application timestamp, to identify if one of the fields of the submitted application has been previously processed. The system verifies if the property address had any previous mortgage activity. The system checks whether the property has been involved recently in a mortgage application based on the Property Identifier (“PID”) is in the system. In embodiments, the MARS 10 generates a PID for each property that is used in a mortgage application. The PID includes a ZIP+4 and two additional unique identifying digits to generate a unique PID. A ZIP+4 code uses the basic five-digit code plus four additional digits to identify a geographic segment within the five-digit delivery area, such as a city block, a group of apartments, an individual high-volume receiver of mail or any other unit. The unique identifier is created by appending the last 2 digits of the address or apartment to the ZIP+4 code. The system also checks if the borrower or the co-borrower has been identified as a borrower or co-borrower based on the SSN. In embodiments, the ZIP+4 code may be replaced by any other postal code used in a specific geographic area.

The default status of the application is set to “open”, which later could be updated to “terminated” or “assigned.” In case of online form data entry, the user is notified with the validation result online. In case of batch data upload, validation results are populated in database. Following validation, results are captured within the system (e.g., database) for future reference. The results may have multiple occurrences, such as, if there was an application filed for this address within the live database, if the borrower has filed for a mortgage within the live database, if the borrower is listed as a co-borrower on an application filed within the live database, if the co-borrower has filed as a primary borrower on a mortgage within the live database, if the co-borrower is listed as a co-borrower on an application filed within the live database. The system may also flag the application if the applicant/co-applicant or property has an existing (or multiple) open application, an existing (or multiple)-closed/assigned application or an existing (or multiple) closed/assigned application. The system provides any MARINS of flagged applications for further investigations.

The determination whether a single property has multiple open applications may be accomplished by comparing PID's of the properties. If it is detected that multiple mortgage applications are directed to the same PID, then the MARS 10 may issue a notification regarding multiple mortgage applications being directed to a single property.

After the applications are validated and entered into the databases, the system assigns mortgage application to lenders. In particular, once the mortgage application is created and MARIN is generated. The broker has following options: 1) assign, mortgage application, within a predetermined time period (e.g., 90 days) to a lender; 2) let the MARIN, mortgage application, expire after a predetermined time period (e.g., 90 days); and 3) terminate the application by closing the mortgage application. Thus, each application and its corresponding MARIN may be in one of the following states, “open,” “expired,” “terminated,” or “assigned.”

The agent may search for a suitable lender. A comprehensive search and validation process allows the mortgage agent to look for any identifying attributes associated with the lender or its agents. This may include a MARS account number, name, address, email address (e.g., of master lender or any lender agent).

The application is assigned by the mortgage originator or agent. A user logs into the system and views all un-assigned application(s), then assigns perspective applications to lenders identified via the search. MARS 10 may display a list of lender companies. Alternately, a user is allowed to invite lender via email for non-MARIN account holder.

MARS also performs automated application handling processes. In particular, MARS performs two automated processes, namely, to update the databases, and to send all sub-account details to a master account holder monthly. This involves updating all modified application data in a perpetual database, and purging mortgage application older than the predetermined time period (e.g., 90 days). For each mortgage application older than the predetermined time period in live database, MARS 10 checks if the application is available in the perpetual database before purging the application.

It is to be understood that the present disclosure may be implemented in various forms of hardware, software, firmware, networks, special purpose processors, or a combination thereof. In one embodiment, the present disclosure may be implemented in software as an application program tangibly embodied on a program storage device. The application program may be executed by a computer system comprising any suitable architecture such as a personal computer, a workstation or server, or mobile computing device.

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A system for recording mortgage applications, the system comprising:
at least one client accessible by a plurality of users granted specific access permissions to at least one database, the plurality of users including:
a first user type allowed to input at least one mortgage application into the at least one database; and
a second user type allowed to review the at least one mortgage application in the at least one database;
at least one server for storing the at least one database including data pertaining to the at least one mortgage application.

2. The system according to claim 1, wherein the at least one database includes at least one live database and at least one reporting database, wherein the at least one live database interfaces with the at least one client and with the at least one reporting database.

3. The system according to claim 2, wherein the at least one live database validates whether the at least one mortgage application has been previously submitted and is stored in the at least one reporting database.

4. The system according to claim 1, wherein the first user type is selected from the group consisting of a mortgage originator, a mortgage lender and a mortgage agent.

5. The system according to claim 1, wherein the second user type is selected from the group consisting of a government regulator and a consumer advocate.

6. The system according to claim 1, wherein the at least one client includes a web-based interface.

7. A method for recording mortgage applications, the method comprising:
receiving at least one mortgage application from at least one first user;
storing the at least one mortgage application in at least one database;
validating the at least one mortgage application;
reviewing the at least one mortgage application by at least one second user; and
assigning the at least one mortgage application to at least one mortgage lender.

8. The method according to claim 7, wherein the receiving further includes inputting data pertaining to the at least one mortgage application through at least one client.

9. The method according to claim 8, wherein the storing further includes storing the at least one mortgage application in at least one live database which interfaces with the at least one client and at least one reporting database.

10. The method according to claim 9, wherein the validating further includes verifying whether the at least one mortgage application has been previously submitted.

11. The method according to claim 10, wherein the verifying further includes searching the at least one reporting database to determine whether any of data pertaining to the at least one mortgage application is stored as part of at least one other mortgage application stored in the at least one reporting database.

12. The method according to claim 7, wherein the method further comprises terminating the at least one mortgage application upon the at least one application being unassigned within a predetermined time period.

13. A method for recording mortgage applications, the method comprising:
receiving at least one mortgage application for at least one property from at least one mortgage agent;
storing the at least one mortgage application in at least one database;
validating the at least one mortgage application;
reviewing the at least one mortgage application by at least fraud monitoring agent; and
assigning the at least one mortgage application to at least one mortgage lender.

14. The method according to claim 13, wherein the receiving further includes inputting data pertaining to the at least one mortgage application through at least one client.

15. The method according to claim 14, wherein the storing further includes storing the at least one mortgage application in at least one live database which interfaces with the at least one client and at least one reporting database.

16. The method according to claim 15, wherein the validating further includes verifying whether the at least one mortgage application has been previously submitted.

17. The method according to claim 16, wherein the verifying further includes searching the at least one reporting database to determine whether any of data pertaining to the at least one mortgage application is stored as part of at least one other mortgage application stored in the at least one reporting database.

18. The method according to claim 17, wherein the verifying further includes searching the at least one reporting database to determine whether the at least one property associated with the at least one mortgage application is stored as part of at least one other mortgage application stored in the at least one reporting database.

19. The method according to claim 13, wherein the method further comprises terminating the at least one mortgage application upon the at least one application being unassigned within a predetermined time period.
